(19) United States
(12) Patent Application Publication
(10) Pub. No.: US 2018/0155587 A1
(43) Pub. Date: Jun. 7, 2018

(54) PROCESS FOR INTEGRATING THERMOSET AND THERMOPLASTIC POLYMERS

(71) Applicant: Advanced Composite Structures Australia Pty Ltd., Port Melbourne, Victoria (AU)

(72) Inventors: Luigi Vandi, Queensland (AU); Michael Heitzmann, Queensland (AU); Rowan Johnson Paton, Victoria (AU)

(21) Appl. No.: 15/737,501

(22) PCT Filed: Jun. 17, 2016
(86) PCT No.: PCT/AU2016/050513

§ 371 Date: Dec. 18, 2017

(30) Foreign Application Priority Data
Jun. 19, 2015 (AU) 2015902368

(51) Int. Cl. C09J 163/00

(52) U.S. Cl. CPC C09J 163/00

(57) ABSTRACT

A method for cross-linking an uncured or partially-cured epoxy resin system, the epoxy resin system including at least one epoxy compound, the epoxy compound including at least one glycidyl chemical group attached to at least one aniline chemical group, the process including:

providing the epoxy resin system with at least a portion of the epoxy compound in contact with a PVDF-containing polymer in a diffuse mixture or at an interface;

and cross-linking at least a portion of the epoxy compound with at least a portion of the PVDF-containing polymer, and in the same process step curing the epoxy resin system, to form a cured epoxy resin system having a cross-linked interface with a PVDF-containing polymer.

### FIELD OF THE INVENTION

The present invention relates to a method for crosslinking an uncured or partially-cured epoxy resin system.

### BACKGROUND OF THE INVENTION

High-performance epoxy resin systems often include thermoplastic materials to enhance mechanical performance such as toughness or improve specific properties (e.g. chemical or UV resistance), or bring additional functionalities to the epoxy resin. Often the thermoplastic used is an amorphous thermoplastic such as PEI, PSU or PES, but other thermoplastics are also used.

Polyvinylidene fluoride (PVDF) has some very attractive properties and is found suitable for various applications due to its excellent characteristics, such as stain resistance, chemical resistance, clarity, ultraviolet ray aging resistance, weatherability, and the ability to repel water and oil, which are not possessed by many thermoplastic materials. However it can be difficult to form a strong interface between PVDF, as a member of the fluoropolymer family, and other polymer materials including epoxies, due to the generally non-stick characteristics of PVDF.

Current epoxy resin adhesives for bonding fluoropolymers such as PVDF, can only achieve simple low quality bonds widely known to possess poor interfacial strength. There are no known adhesives for PVDF polymers that give bonds of adequate strength without pre-treatment or modification of the PVDF polymer.

Some previous efforts to make a strong interface between PVDF and epoxy resins were directed towards obtaining an effective physical blend at least locally of the two components during the cure of the epoxy resin system. Patent publication WO2003011573 describes the use of a semi-crystalline polymer (preferably PVDF) in combination with a thermosetting polymer, where the uncured thermosetting polymer and the semi-crystalline thermoplastic polymer are able to at least partly interpenetrate during the curing of the thermosetting polymer. The strength of the interface between the two materials is described as being achieved by molecular entanglement, as a result of at least partial physical interpenetration between the two polymers. In patent publication WO9808906, a method for forming a semi-interpenetrating polymer network (sIPN) between epoxy resin and a fluoropolymer (preferably THV (a copolymer of tetrafluoroethylene, hexafluoropropylene, and vinylidenefluoride), and optionally a polyolefin or polyamide, is described. The sIPN, a physical interpenetration of the macromolecules, is obtained by curing the epoxy resin in the presence of the fluoropolymer.

Some patent publications describe modifications of PVDF polymer in order to alter its chemical interactions with specific functional groups, possibly allowing other polymers to make a stronger interface with the modified PVDF. These modifications can be performed either during the polymerisation process (e.g. by co-polymerisation), or by a post-polymerisation process (e.g. by grafting). Alternatively only the surface of a PVDF component may be modified (e.g. by surface treatments or chemical etching of a PVDF film).

Patent publication WO2007060367 describes a process in which functional groups are introduced into the PVDF polymer chain by co-polymerisation of VDF monomers with at least one monomer containing the functional group. In still further patent publications a functionalised PVDF is described, where the final polymer is obtained by co-polymerisation with monomers containing groups such as maleic anhydride (WO2006045637, WO2006042763, WO2005115753, and FR2876698), vinylene carbonate (U.S. Pat. No. 5,415,958), or citraconic anhydride (U.S. Pat. No. 670,346,582).

In EP751157, a modified PVDF produced by co-polymerising VDF monomers with a monomer containing an epoxy functional group (otherwise known as an epoxide group or epoxy ring) is described. The epoxy functional groups themselves do not react with the VDF unit; they remain unreacted and attached to the monomer unit that is being co-polymerised with the VDF units (see FIG. 1). EP751157 discloses that the purpose of this epoxy functional group is to allow the modified PVDF to have reactive sites which can be used to react with functional groups grafted on another polymer chain, typically maleic anhydride. The modified PVDF obtained can have an improved adhesion to metal substrate which is discussed as being useful in applications for a secondary battery.

Patents publications FR2894602 and WO199603448 describe modified PVDF polymers containing polar monomer groups, grafted in a separate step following the polymerisation process using gamma or beta radiation. The grafted modified PVDF polymer is used to achieve a good adhesion with textiles, thereby offering a good chemical resistance and anti-stain properties.

Patent publication WO200248201 describes a method for modifying the surface of various fluoropolymers (preferably PTFE). The method involves an etching process in the presence of surface-active materials to produce a hydrophilic polymer surface. Patent publication WO9324299 describes a discharge treatment in an inert gas atmosphere containing functional groups which is proposed for fluoropolymer surfaces.

The PVDF film can form part of a multilayer laminate, in which case the adhesion of the PVDF film to a substrate (typically a metal) is often achieved via the use of a separate tie layer. In patent publication EP1637319, a tie layer comprising a functionalised PVDF and a functionalised polyethylene (a strong adhesion being achieved by the interactions between functional groups from separate polymers) is combined with PVDF film to form a multilayer barrier film suitable for pipe or reservoirs containing fluids.

There is a need to provide a direct method for forming strong interfaces between fluoropolymers such as PVDF, and cured epoxy resin systems.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In one aspect of the invention, there is provided a method for cross-linking an uncured or partially-cured epoxy resin system, the epoxy resin system including at least one epoxy compound, the epoxy compound including at least one glycidyl chemical group attached to at least one aniline chemical group, the process including:

providing the epoxy resin system with at least a portion of the epoxy compound in contact with a PVDF-containing polymer in a diffuse mixture or at an interface;

subjecting the epoxy resin system and the PVDF-containing polymer to cross-linking conditions which allow the cross-linking of at least a portion of the epoxy compound with at least a portion of the PVDF-containing polymer, and also the curing of the components comprising the epoxy resin system;

and cross-linking at least a portion of the epoxy compound with at least a portion of the PVDF-containing polymer, and in the same process step curing the epoxy resin system, to form a cured epoxy resin system having a cross-linked interface with a PVDF-containing polymer.

In an embodiment, the PVDF-containing polymer is a polyvinylidene fluoride homopolymer. Preferably, the homopolymer consists of VDF monomer units that are in a head-to tail configuration.

The term head-to-tail configuration is intended to describe the arrangement where sequential VDF monomer units (—[CH₂—CF₂]—) are arranged such that the —CF₂— unit is located adjacent to two —CH₂— units, e.g. —[CH₂—CF₂]—[CH₂—CF₂]—[CH₂—CF₂]— etc. This provides highly polar PVDF segments in the PVDF polymer chain which is advantageous in forming a strong crosslinked interface.

In an alternative embodiment, the PVDF-containing polymer is a thermoplastic copolymer or thermoplastic branched polymer; wherein the copolymer or branched polymer includes one or more PVDF containing portions formed from VDF units and one or more non-PVDF containing portions; wherein the PVDF-containing polymer includes at least 50 wt % VDF-containing portions. A high proportion of PVDF-containing portions is advantageous as it assists in providing a strong cross-linked interface with the cured epoxy resin system. More preferably, the PVDF-containing polymer includes at least 70 wt % VDF-containing portions. Most preferably, the PVDF-containing polymer includes at least 85 wt % VDF containing portions.

It is further preferred that, at least 90% of the VDF-containing portions in the PVDF-containing polymer are in a head-to-tail configuration.

In an embodiment, the partially-cured, or uncured, epoxy resin system includes at least 10 wt % of at least one epoxy compound.

In an embodiment, the epoxy compound includes two glycidyl chemical groups attached to the at least one aniline chemical group. More preferably, the aniline chemical group is a diglycidyl aminophenol.

Preferably, the epoxy compound includes at least two aniline chemical groups, each aniline chemical group including at least one glycidyl groups. More preferably, each aniline chemical group includes at least two glycidyl groups. Even more preferably, the epoxy compound includes two aniline chemical groups, and the two aniline groups are located at opposite terminal ends of the epoxy compound from each other.

Most preferably, the epoxy compound is selected from the group consisting of tetraglycidyl diamino diphenyl methane (TGDDM), triglycidyl-p-aminophenol (TGPAP), or triglycidyl-m-aminophenol (TGMAP).

In an embodiment, the epoxy resin system includes at least one epoxy compound in an amount of at least 10 wt % of the epoxy resin system, preferably 20 wt %, more preferably 30 wt %, of the epoxy resin system.

In an embodiment, the cross-linked interface would, if included in the manufacture of a single-lap shear joint between predominantly carbon fibre epoxy laminates of 12.5 mm overlap, and tested according to EN2243, allow that joint to have an average shear strength at room temperature of at least 25 MPa. More preferably, the cross-linked interface would, if included in the manufacture of a single-lap shear joint between predominantly carbon fibre epoxy laminates of 12.5 mm overlap, and tested according to EN2243, allow that joint to have an average shear strength at room temperature of at least 30 MPa.

In an embodiment, the cross-linked interface would, if included in the manufacture of a single-lap shear joint between predominantly carbon fibre epoxy laminates of 12.5 mm overlap, and tested according to EN2243, be sufficiently strong as to allow that single-lap shear specimen to fail at a location other than at the cross-linked interface.

In an embodiment, the step of cross-linking the PVDF-containing polymer and the epoxy compound occurs at a reaction temperature above a melting point of the PVDF-containing polymer.

In an embodiment, the step of providing the epoxy resin system with at least the portion of the epoxy compound in contact with a PVDF-containing polymer at an interface, further includes providing the PVDF-containing polymer and the epoxy compound, each with solubility parameters such that the solubility parameters of the epoxy compound and the PVDF-containing polymer have a Relative Energy Difference (RED) value of less than 1.

In an embodiment, the step of cross-linking the epoxy compound and the PVDF-containing polymer results in an exothermic enthalpy of reaction, observable using dynamic Differential Scanning Calorimetry (DSC) analysis.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1: Illustration of an epoxy functional group.

FIG. 2: Illustration of PVDF showing local polarity of PVDF chains due to the alternating —[CH₂—CF₂]— structure.

FIG. 3: Illustration of the chemical structure of diglycidyl aminophenol.

FIG. 4: Schematic showing a first mechanism for chemical cross-linking between an epoxy compound and PVDF chains.

FIG. 5: Schematic showing a second mechanism for chemical cross-linking between an epoxy compound and PVDF chains.

FIG. 6: Schematic showing a third mechanism for chemical cross-linking between an epoxy compound and PVDF chains.

### DETAILED DESCRIPTION OF THE EMBODIMENTS

In applications where the strongest interface between a cured epoxy resin system and a PVDF-containing polymer is required, it is desirable to achieve chemical bonding between the two materials. The prior art does not provide a mechanism of achieving cross-linking (chemical bonding) directly between an epoxy resin system and a commercially-available, unmodified, PVDF; or directly between an epoxy resin system and the PVDF chains in a PVDF-containing polymer.

The term PVDF-containing polymer is intended to describe polymers that include chains of polymerised VDF monomers. In certain embodiments, the PVDF-containing polymer is a PVDF homopolymer. In other embodiments, the PVDF-containing polymers have VDF-containing sections and non-VDF-containing sections; in such cases the PVDF-containing polymer may be a co-polymer or branched polymer.

The present invention provides a process for achieving a chemical reaction resulting in cross-links between an epoxy resin system and a PVDF-containing polymer, during the cure of the epoxy resin system. This process can be called co-curing of the PVDF-containing polymer with, or crosslinking of the PVDF-containing polymer to, an epoxy resin system, as the crosslinks between the epoxy compounds in the epoxy resin system and the PVDF-containing polymer are formed during the same general process step as the expected curing of the epoxy compounds and any hardener in the epoxy resin system.

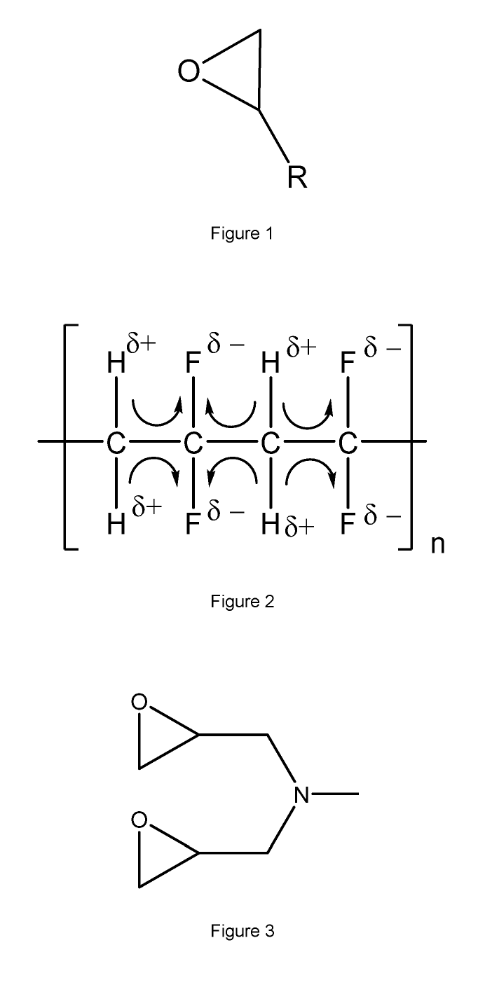

Preferably the PVDF described in this application, which is hereafter called a PVDF-containing polymer, is polyvinylidene fluoride (PVDF) homopolymer, or a PVDF co-polymer comprising at least 50 wt % of polyvinylidene fluoride structural chains and at least one other monomer or polymer, or a branched copolymer. The PVDF-containing polymer possesses PVDF chains with at least localised alternations of —CF₂— and —CH₂— functional groups in the form of a head-to-tail sequence of [CH₂—CF₂] structural units, (i.e. —[CH₂—CF₂]—[CH₂—CF₂]—), giving the PVDF polymer chains strong local polarity due to the high electronegativity of Fluorine and the low electronegativity of Hydrogen, as shown in FIG. 2. In order for the PVDF-containing polymer to make sufficient crosslinks when co-cured with the epoxy resin system, it will preferably include at least 50% wt % of chains made up with VDF [CH₂—CF₂] structural units in head-to-tail sequence, and more preferably at least 85% of chains made up with VDF [CH₂—CF₂] structural units in head-to-tail sequence.

The epoxy resin system includes one or more epoxy compounds. The epoxy resin system may also contain one or more hardeners such as DDS, and/or other polymers or substances such as toughening agents or fillers, and/or reinforcing fibres or functional materials. The epoxy resin system is initially uncured or only partially-cured, and may be premixed as in epoxy prepreg, or mixed just before curing. At any stage before curing it may be combined with fillers or fibres or other substances so that, after curing, it may make up part of an epoxy composite material or structure.

The epoxy resin system preferably includes one or more multi-functional epoxy compounds, containing at least one diglycidyl aminophenol (FIG. 3) structure in the epoxy compound. Preferably the epoxy resin system includes one or more of these multi-functional epoxy compounds such as tetraglycidyldiaminodiphenyl methane (TGDDM), triglycidyl-p-aminophenol (TGPAP), or triglycidyl-m-aminophenol (TGMAP). In order for the multifunctional epoxy compound containing the diglycidyl aminophenol structure to react sufficiently with the PVDF-containing polymer, these epoxy compounds will preferably make up at least 10% wt of the epoxy resin system, and ideally make up at least 25% wt of the epoxy resin system.

The uncured or partially-cured epoxy resin system and the PVDF-containing polymer are brought into intimate contact in the course of a manufacturing process. Depending on the manner in which the contact is achieved, the process can result in a polymer composite laminate; or a cured, mostly thermoset resin component; or a material such as a coating; or a hybrid material or component, to be used subsequently in a manufacturing process, or in the course of manufacturing any other component or part; or any other type of hybrid of epoxy and PVDF-containing polymers.

The curing process of the epoxy resin system is chosen based on the cure kinetics of the epoxy resin system, and/or the needs of the relevant manufacturing process, and/or the requirements of the cross-linking reaction between the PVDF-containing polymer and the epoxy compound(s). It can be achieved at elevated temperature, or with the assistance of UV or other radiation. It is preferable that the curing process of the epoxy resin is performed at elevated temperature, more preferably above the melting point of the PVDF-containing polymer. It should be noted that the melting point of the PVDF-containing polymer may be altered by contact with any of the ingredients of the epoxy resin system. This altered melting point is known as the effective melting point. Preferably the curing process should be carried out above the effective melting point of the PVDF-containing polymer. More preferably the curing process should be carried out above the normal melting point of the PVDF-containing polymer.

The reaction between the epoxy compound(s) and the PVDF-containing polymer, which is the current invention, occurs during the curing process of the epoxy resin system as a whole and results in cross-links being formed between the epoxy compound or compounds and the PVDF chains in the PVDF-containing polymer. These crosslinks are formed during the same general period and process step as the curing of the components of the epoxy resin system.

The chemical reaction between the epoxy compounds and the PVDF-containing polymer may occur through one or more of at least three possible mechanisms to give alternative chemical structures as described below.

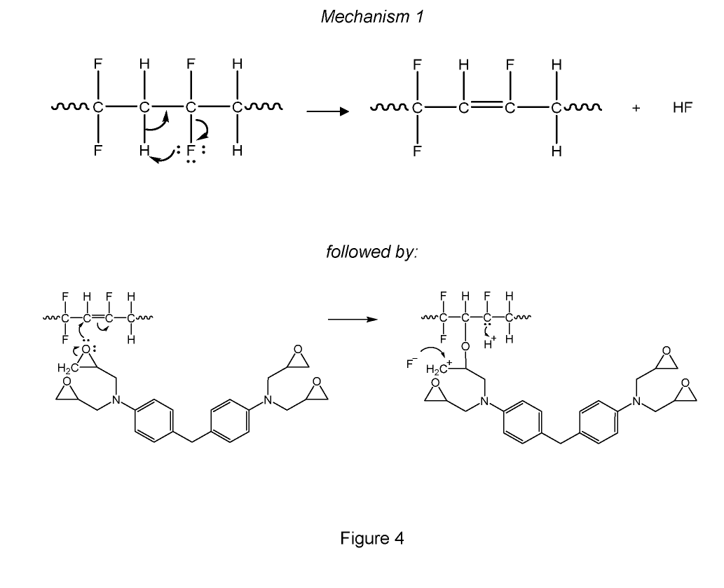

A first mechanism involves dehydrofluorination of the PVDF chains in the PVDF-containing polymer, followed by cross-linking of the epoxy compound via its epoxy functional group to the PVDF polymer chain. A mechanism for this process is shown in FIG. 4. The dehydrofluorination reaction may occur anywhere along the PVDF chain, but is more likely to be initiated at or near weak segments along the chain. These weak segments may be associated with radicals or other compounds from the polymerisation process which have branched onto the polymer chain, or defect structures in the polymer chain, such as head-to-head or tail-to-tail additions.

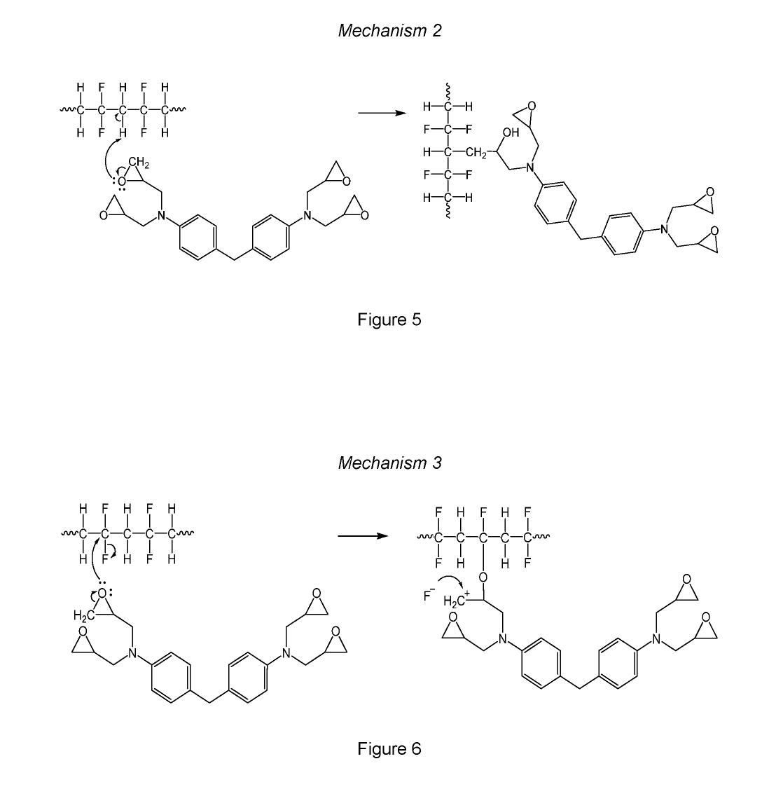

A second mechanism involves ring-opening of the epoxy functional group, (which is known to be increased in an acidic environment, such as in the presence of HF or a curing agent) followed by cross-linking to the PVDF polymer chain, as shown in FIG. 5.

A third mechanism involves ring-opening of the epoxy functional group, (which is known to be increased in an acidic environment, such as in the presence of HF or a curing agent) followed by cross-linking to the PVDF polymer chain, as shown in FIG. 6. Such cross-linking of the epoxy functional group onto the PVDF polymer chain as described in the second or third processes may occur anywhere along the PVDF chain, but is more likely to be initiated in the vicinity of a weak segment (e.g. a branched compound or defect structure) or directly onto a branched compound on the chain. Such a branched compound may have been introduced, deliberately or otherwise, during the polymerisation process of the PVDF-containing polymer.

Without wishing to be bound by theory, the inventors believe that the cross-linking reaction occurs via one or more of the three alternative mechanisms described above.

It should be noted that the crosslinking processes described above occur directly between an epoxy functional group on the epoxy compound and a VDF-containing section of the PVDF-containing polymer, during the process step of subjecting the epoxy resin system and the PVDF-containing polymer to cross-linking conditions which allow the cross-linking of at least a portion of the epoxy compound with at least a portion of the PVDF-containing polymer, and also the curing of the components comprising the epoxy resin system. No other process steps or intermediate chemical linkages are required to form the cross-links.

It should be noted that, where the PVDF-containing polymer includes sections not consisting of polymerised VDF units, the reaction (cross-linking) occurs between an epoxy functional group in the epoxy compound and the VDF-containing sections of the PVDF-containing polymer, such as within or at the ends of the VDF-containing sections.

The present invention includes methods for selecting and verifying suitable PVDF-containing polymers and epoxy compounds, which can cross-link under appropriate conditions.

The epoxy resin system preferably includes one or more multi-functional epoxy compounds, each containing at least one diglycidyl aminophenol structure (see FIG. 2).

The PVDF-containing polymer preferably includes at least 50 wt % of [CH₂—CF₂] VDF units, and preferably has a melting temperature (Tₘ) at or below a practical cure temperature suitable for the epoxy resin system. The PVDF-containing polymer can be one polymerised by a suspension process or by an emulsion process. Ideally the PVDF-containing polymer is polymerised in a way, or subsequently treated in a way, which minimises or eliminates the possible presence of polymerisation residues such as emulsifiers, for instance in a suspension polymerisation process.

The Hansen Solubility Parameter (HSP) of at least one of the epoxy compounds is preferably close to the HSP of the PVDF or the PVDF-containing polymer, to assist the two substances to come into intimate contact and the cross-linking to proceed. The Relative Energy Difference (RED) between the HSPs is preferably less than 1.

A method for selection and verification of suitable PVDF-containing polymer and epoxy compounds is to test for the presence of the cross-linking reaction during a DSC scan of a specially-prepared blended sample. This is done by obtaining the PVDF-containing polymer in powder form (with a particle size preferably between 1 μm and 100 μm), and blending it with an individual multifunctional epoxy compound such as TGDDM. The weight ratio of the PVDF-containing polymer in the blended DSC sample is preferably in the range of 20 to 40% wt. The blended sample comprising the PVDF-containing polymer and the epoxy compound is analysed by Differential Scanning Calorimetry (DSC) according to the procedure described in ASTM E2160.

The DSC dynamic thermogram of blended samples which are able to cross-link will exhibit an exothermic peak, not otherwise observed when the PVDF-containing polymer and the epoxy components are analysed by DSC on their own. This exothermic peak represents the enthalpy of reaction generated as a result of the cross-linking between the epoxy compound and the PVDF-containing polymer. The exothermic peak is typically found at a temperature above the Tₘ of the VDF-containing polymer and below the homo-polymerisation reaction temperature of the epoxy compound.

In the present invention, the cross-linking reaction between epoxy compounds and PVDF-containing polymer can be used to form a particularly strong interface between these thermosetting and thermoplastic materials. It should be noted that this interface may include an interphase (an intermediate region including epoxy chains and PVDF-containing polymer chains, and some cross-linked together, which may possess different properties from the two bulk individual materials). The strength of the interface formed can be measured by mechanical testing of a joint including this interface. A single-lap shear joint can be made between cured epoxy composite adherends, each with a PVDF-containing co-cured polymer surface. The strength of the interface described in this invention is sufficient to result in an average tensile shear strength at room temperature of at least 25 MPa in such joints, and/or is sufficient to result in joint failure other than in the interface region (for instance in the PVDF-containing polymer or in the epoxy composite laminate) when joint specimens are manufactured and tested according to EN 2243.

Prior to the cross-linking occurring, the epoxy resin system and the PVDF-containing polymer may be in separate regions in intimate contact, or may be in a coarse or fine mixture, or may be in a state in which one is at least partially dissolved in the other. The cross-linking may result in strong interfaces between cured epoxy system regions and PVDF-containing polymer regions, or result in an interphase containing a substantial portion of an epoxy resin system crosslinked with a PVDF-containing polymer, or result in both. If the PVDF-containing polymer in contact with the epoxy resin system is in the form of sufficiently fine particles (less than 1000 nm in diameter) following cocuring there may be no phase which includes PVDF-containing polymer only.

The epoxy resin system to be crosslinked with the PVDF-containing polymer may contain less conventional hardener than is conventionally specified, or even no conventional hardener at all.

The epoxy resin system may be initially uncured, or partially cured. Results to date suggest that epoxy resin systems which are substantially cured at the point at which the PVDF-containing polymer melts in the curing cycle may have insufficient unreacted epoxy functional groups to form a strong cross-linked interface. Preferentially the epoxy resin system should be less than 50% cured at the point in the heating and cure cycle at which the PVDF-containing polymer becomes melted. Ideally the epoxy resin system should be less than 25% cured at the point in the heating and cure cycle at which the PVDF-containing polymer becomes melted.

The invention has many potential applications as it allows a thermoplastic-thermoset hybrid component or material to be made, through a one-stage process, in which the interface between the thermoplastic and cured thermoset regions is extremely strong.

A strongly-integrated thermoplastic surface film can be used to make a thermoplastic weld between a thermoset resin component or thermoset composite component, and another component with a similar or compatible thermoplastic surface.

A strongly-integrated thermoplastic surface film can be used to enhance the surface properties, for example the environmental resistance, of a cured thermoset resin component or a cured thermoset composite component.

Strongly-integrated thermoplastic filler particles can be used to modify physical or mechanical properties of a thermoset resin or thermoset composite.

Strongly-integrated thermoplastic filler particles can be used to modify physical or mechanical properties of a thermoset resin coating.

A PVDF-modified epoxy polymer, or an epoxy-modified PVDF polymer, may be used to make components with desirable properties.

### EXAMPLES

### Example 1

A suitable epoxy resin system was obtained in the form of a carbon fibre sheet pre-impregnated with a partially-cured (“B”-staged) epoxy resin. This prepreg material is commercially available under the name of HexPly® M21 and was purchased from Hexcel in 2010. This prepreg is thought to contain 29% wt of tetraglycidyldiaminodiphenyl methane (TGDDM), and cures through a recommended cycle which includes 2 hours at 180° C.

The PVDF-containing polymer was PVDF, supplied in film form, and made from Kynar® 740 PVDF Film purchased from Westlake Plastics in 2004. It contains at least 85% of [CH₂—CF₂] units, and has a melting temperature of −167° C.

The Hansen solubility parameters of TGDDM and PVDF are (δD 18.1, δP 9.6, δH 10.1), and (δD 17, δP 12.1, δH 10.2) respectively. This leads to a RED value between the two materials of 0.67 (well below 1).

DSC analysis, with heating at 10° C./minute, of a blend comprised of 20% wt PVDF/80% wt TGDDM, indicated an obvious exothermic reaction, above the melting temperature of the PVDF and below the homo-polymerisation temperature of TGDDM.

To obtain a cross-linked interface between the epoxy resin system and the PVDF for mechanical testing, PVDF film was laid up as the first ply in a carbon-epoxy composite laminate otherwise consisting of a stack of HexPly® M21 unidirectional carbon-epoxy prepreg tape, and co-cured according to a recommended M21 cure cycle including 2 hours at 180° C., under a vacuum bag, and 6 bar of autoclave gauge pressure. Two sections of the cured laminate resulting were then welded together through their PVDF surfaces above the melting temperature of the PVDF.

The average tensile shear strength achieved for the 12.5 mm overlap, single-lap, shear specimens made in this way, and tested at room temperature, according to EN2243, was 35 MPa.

### Example 2:

A suitable epoxy resin system was obtained in the form of a carbon fibre sheet pre-impregnated with a partially-cured (“B”-staged) epoxy resin. This prepreg material is commercially available under the name of HexPly® M21 and was purchased from Hexcel in 2012. This prepreg is thought to contain 29% wt of tetraglycidyldiaminodiphenyl methane (TGDDM), and cures through a recommended cycle which includes 2 hours at 180° C.

The PVDF-containing polymer was a copolymer of VDF monomer units and hexafluoropropylene (HFP) units, named Kynar Flex® 3120-10. The film was manufactured in-house from pellets purchased from Arkema in 2013.

DSC analysis, with heating at 2° C./minute, of a blend comprised of 40% wt VDF-HFP copolymer/60% wt TGDDM indicated an obvious exothermic reaction, above the melting temperature of the VDF-HFP copolymer and below the homo-polymerisation temperature of TGDDM.

To obtain a cross-linked interface between the epoxy resin system and the PVDF-containing polymer for mechanical testing, the VDF-HFP film was laid up as the first ply in a carbon-epoxy composite laminate otherwise consisting of a stack of HexPly® M21 unidirectional carbon-epoxy prepreg tape and co-cured according to a recommended M21 cure cycle including 2 hours at 180° C., under a vacuum bag, and 6 bar of autoclave gauge pressure. Two sections of the laminate resulting were then welded together above the melting temperature of the PVDF-containing polymer.

The average tensile shear strength achieved for the 12.5 mm overlap, single-lap shear specimens made in this way, and tested at room temperature according to EN2243, was 26 MPa. The failure mode was largely cohesive in the VDF-HFP film itself.

It will be understood that the invention disclosed and defined in this specification extends to all alternative combinations of two or more of the individual features mentioned or evident from the text or drawings. All of these different combinations constitute various alternative aspects of the invention.

1. A method for cross-linking an uncured or partially-cured epoxy resin system, the epoxy resin system including at least one epoxy compound, the epoxy compound including at least one glycidyl chemical group attached to at least one aniline chemical group, the process including:
providing the epoxy resin system with at least a portion of the epoxy compound in contact with a PVDF-containing polymer in a diffuse mixture or at an interface;
subjecting the epoxy resin system and the PVDF-containing polymer to cross-linking conditions which allow the cross-linking of at least a portion of the epoxy compound with at least a portion of the PVDF-containing polymer, and also the curing of the components comprising the epoxy resin system;
and cross-linking at least a portion of the epoxy compound with at least a portion of the PVDF-containing polymer, and in the same process step curing the epoxy resin system, to form a cured epoxy resin system having a cross-linked interface with a PVDF-containing polymer.

2. The method of claim 1, wherein the PVDF-containing polymer is a polyvinylidene fluoride homopolymer.

3. The method of claim 2, wherein the homopolymer consists of VDF monomer units, and at least 90% of the VDF-containing portions are in a head-to-tail configuration.

4. The method of claim 1, wherein the PVDF-containing polymer is a thermoplastic copolymer, or a branched thermoplastic polymer;
wherein the copolymer or branched polymer includes one or more VDF-containing portions formed from VDF units and one or more non-VDF containing portions;
wherein the PVDF-containing polymer includes at least 50 wt % VDF-containing portions.

5. The method of claim 4, wherein the PVDF-containing polymer includes at least 70 wt % VDF-containing portions.

6. The method of claim 5, wherein at least 90% of the VDF-containing portions in the PVDF-containing polymer are made up of VDF units in a head-to-tail configuration.

7. The method of claim 1, wherein the uncured or partially-cured epoxy resin system includes at least 10% wt of an epoxy compound.

8. The method of claim 7, wherein the epoxy compound includes two glycidyl chemical groups attached to at least one aniline chemical group.

9. The method of claim 8, wherein the aniline chemical group is a diglycidyl aminophenol.

10. The method of claim 7, wherein the epoxy compound includes at least two aniline chemical groups, each aniline chemical group including at least one glycidyl group.

11. The method of claim 10, wherein each aniline chemical group includes at least two glycidyl groups.

12. The method of claim 10 or 11, wherein the epoxy compound includes two aniline chemical groups, and the two aniline groups are located at opposite terminal ends of the epoxy compound from each other.

13. The method of claim 7, wherein, the epoxy compound is selected from the group consisting of tetraglycidyl diamino diphenyl methane (TGDDM), triglycidyl-p-aminophenol (TGPAP), or triglycidyl-m-aminophenol (TGMAP).

14. The method of claim 1, wherein, the epoxy resin system includes at least one epoxy compound in an amount of at least lOwt % of the epoxy resin system.

15. The method of claim 1, wherein the epoxy resin system includes at least one epoxy compound in an amount of at least 25 wt % of the epoxy resin system.

16. The method of claim 1, wherein the cross-linked interface would, when tested as part of a single-lap shear joint between composite laminates according to EN2243, have an average tensile strength at room temperature of at least 25 MPa.

17. The method of claim 1, wherein the cross-linked interface would, when tested as part of a single-lap shear joint between composite laminates according to EN2243, be sufficiently strong to cause failure at a location other than at the cross-linked interface.

18. The method of claim 1, wherein the step of cross-linking the epoxy compound and the PVDF-containing polymer occurs at a reaction temperature above a melting point of the PVDF-containing polymer.

19. The method of claim 1, wherein the step of providing the epoxy resin system with at least a portion of the epoxy compound in contact with a PVDF-containing polymer in a diffuse mixture or at an interface, further includes providing the epoxy compound and the PVDF-containing polymer, each with solubility parameters such that the solubility parameters of the epoxy compound and the PVDF-containing polymer have a Relative Energy Difference (RED) value of less than 1.

20. The method of claim 1, wherein the step of cross-linking the epoxy compound and the PVDF-containing polymer results in an exothermic enthalpy of reaction, observable using dynamic Differential Scanning Calorimetry (DSC) analysis.
